(19) United States
(12) Patent Application Publication
(10) Pub. No.: US 2008/0061174 A1
(43) Pub. Date: Mar. 13, 2008

(54) Blending device with a dispenser

(75) Inventors: Scott Patrick Comstock, LaCanada, CA (US); Kurt Joseph Comstock, Sylmar, CA (US); Gregg Alan Bond, Beverly Hills, CA (US)

Correspondence Address: YING CHEN;Chen Yoshimura LLP, 255 S. GRAND AVE., # 215, LOS ANGELES, CA, 90012, US

(73) Assignee: The Helman Group, Ltd.

(21) Appl. No.: 11/503,702

(22) Filed: Aug. 11, 2006

(51) Int. Cl. B02B 5/02

(52) U.S. Cl. 241/101.2

(57) ABSTRACT

A blender includes a base for housing a motor, an insulated, removable mixing container mounted on the base with a dispenser for dispensing content from the container, a lid, and a grinding and shaving assembly disposed inside the mixing container near its bottom. The grinding and shaving assembly includes a grinding and shaving blade assembly attached to a rotating shaft and a screen disposed around the grinding and shaving blade assembly. The screen is spaced from an inner sidewall of the mixing container to form a space between the screen and the inner sidewall. An opening is defined near a bottom of the mixing container to form a fluid passage between the space and the dispenser. A safety switch is provided so that the blender will not run unless the lid is closed. Either an AC or a DC motor may be used, with a build-in DC-AC or AC-DA converter.

### BACKGROUND OF THE INVENTION

1. Field of the Invention

This invention relates to an apparatus for blending ingredients for making and dispensing a beverage.

2. Description of the Related Art

Blenders are widely used in homes to make soups, sauces, ices, slushy drinks, smoothies and other beverages, etc. There have also been attempts to make larger blenders for home use which have insulated containers and stronger blender blades for crushing ice and making cold drinks.

### SUMMARY OF THE INVENTION

There is a need for a well designed, sturdy and easy to use blender and ice crusher for home or commercial use.

The present invention is directed to a blender device with a liquid dispenser that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a blender which includes: a base for housing a motor; a mixing container mounted on top of the base, the mixing container having a dispenser for dispensing a content from the container; a lid for covering the mixing container; and a grinding and shaving assembly disposed inside the mixing container near its bottom, the grinding and shaving assembly including a grinding and shaving blade assembly attached to a rotating shaft and a screen disposed around the grinding and shaving blade assembly, the screen being spaced from an inner sidewall of the mixing container to form a space between the screen and the inner sidewall, and wherein an opening is defined near a bottom of the mixing container to form a fluid passage between the space and the dispenser. The mixing container is preferably insulated and detachable from the base.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a perspective view illustrating the exterior of a blender with dispenser according to an embodiment of the present invention.

FIG. 2 is an exploded view illustrating the base and mixing container of the blender of FIG. 1.

FIG. 3 is an exploded view of the grinding and shaving assembly of the blender of FIG. 1.

FIG. 4 is a perspective view of the blender of FIG. 1 with the lid removed showing the grinding and shaving assembly mounted inside the mixing container.

### DETAILED DESCRIPTION OF THE PREFERRED EMBODIMENTS

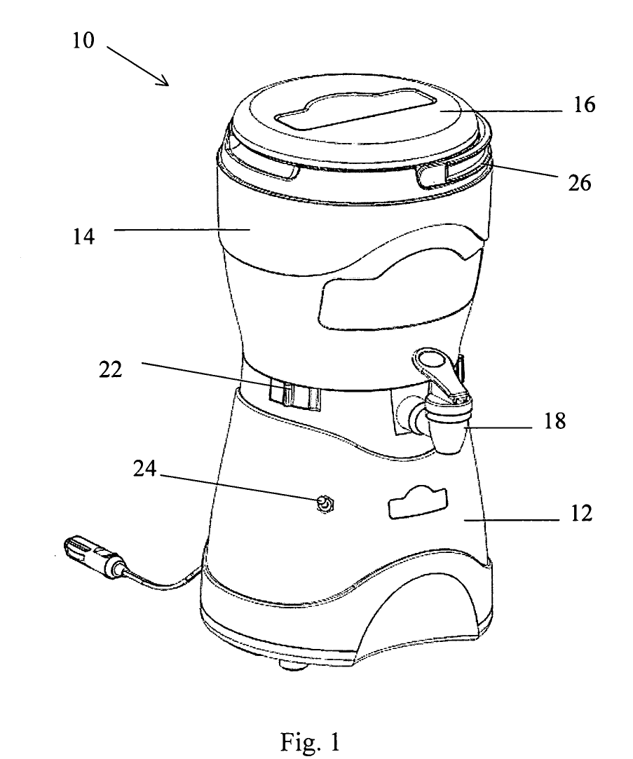

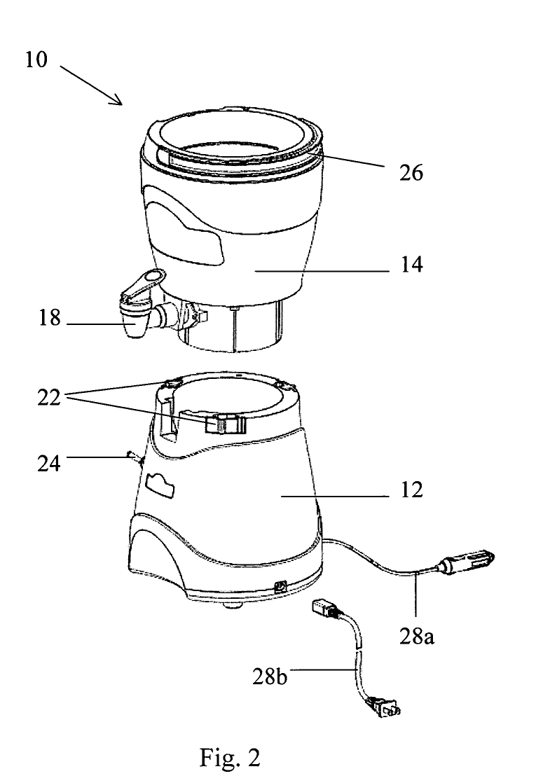

Embodiments of the present invention are described with reference to the attached drawings. As shown in FIGS. 1 and 2, the blender 10 includes a base 12, a mixing container 14 mounted on the base 12, and a lid 16 for covering the container 14. The base 12, container 14 and lid 16 are preferable made of plastic materials. A dispenser 18 is provided on the container 14 to dispense liquid (including thick liquid and small solids) from the container. The mixing container 14 is insulated to keep the content cold, and is removable from the base 12 for easy cleaning. A plurality of locking members 22 are provided to securely lock the container 14 to the base 12 when in use. The locking members 22 may have any suitable design, such as hooks and wires on the outside of the base 12 and the container 14, or male and female parts on the base 12 and container 14 that fits into each other with a sliding lock, etc. A motor is installed inside the base 12, and a switch 24 is provided for turning on and off the motor.

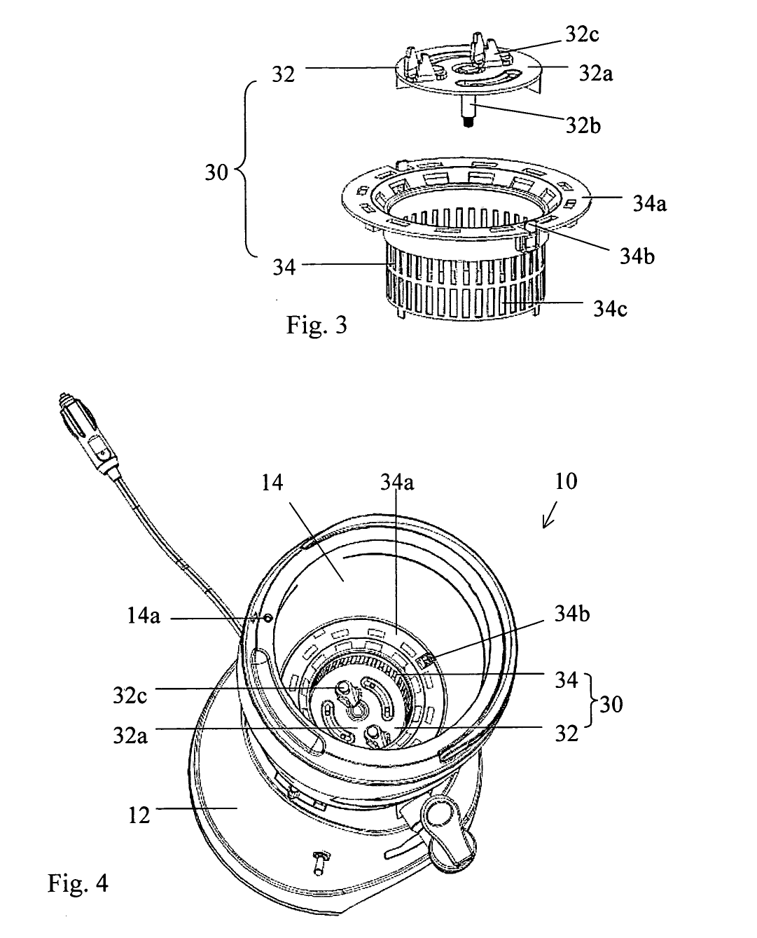

The lid 16 may be either removable or attached to the mixing container with a hinge. In an embodiment where the lid is removable, to ensure that the lid 16 is properly closed, one or more protrusions (not shown) are provided on the periphery of a lower surface of the lid corresponding in position and size to one or more small holes on the top surface of the rim of the mixing container 14 (one hole 14a is shown in FIG. 4). The protrusion(s) are inserted into the hole(s) when the lid 16 is properly placed, and prevents the lid 16 from shifting laterally or rotating when the blender is running. In addition, one or more safety switches may be installed inside the hole(s). The switch(es) is activated when the protrusion(s) is inserted into the hole(s), so that the motor will not run unless the lid 16 properly in place and the protrusion(s) is inserted into the hole(s).

A handle 26 is provided near the top of the mixing container for convenient carrying and transporting of the blender device. In one embodiment, the handle 26 flips up for carrying the blender, and flips back down flush with the lid 16 and out of the way while the unit is in use.

As shown in FIGS. 3 and 4, a grinding and shaving assembly 30 is installed near the bottom inside the mixing container 14 and functions to grind and shave the content in the mixer such as ice and fruits. The grinding and shaving assembly includes a grinding and shaving blade assembly 32 and a screen 34. The grinding and shaving blade assembly 32 and the screen 34 are made of food grade material, such as stainless steel, aluminum and/or plastic. In one embodiment, the grinding and shaving blade assembly 32 is an assembly commonly used in commercially available garbage disposals for home kitchen sinks. It includes a round rotating base plate 32a attached to and rotating with a rotating shaft 32b, and one or more (preferably two) swiveling metal blades 32c attached to the base plate 32a at off-centered positions. The swiveling blades 32c swivel independently of each other. Such commercially available grinding and shaving blade assemblies are adequate and efficient for grinding ice and mixing ingredients for typical cold drinks. Other suitable types of grinding and shaving blade assembly may be used, including custom designed ones. The lower end of the rotating shaft 32b protrudes from the bottom of the mixing container and has a head (not shown) adapted for engaging a rotating socket on the base 12 when the mixing container 14 is properly situated on the base. The socket and the head engage each other to transmit the force of the motor to rotate the grinding and shaving blade assembly.

The screen 34 is preferably cylindrically shaped, but it may also have other suitable shapes such as tapered cylinder, drum or inverse drum shaped, etc. The screen 34 is disposed at the bottom of the mixing container 14 around the grinding and shaving blade assembly 32 and spaced apart from the inner sidewall of the mixing container to form a ring shaped space between the screen and the inner wall of the mixing container. At the top of the screen 34 is a flange 34a having an outer dimension substantially the same as an inner dimension of the mixing container to keep the screen in place (see FIG. 4). Optionally, the inner wall of the mixing container has a shoulder for the flange to rest on, and the flange has one or more locking clips 34b (or other locking mechanisms) for locking the screen 34 to the inside of the mixing container. The screen 34 is removable (by unlocking the clips) for easy cleaning. Alternatively, instead of a flange portion, a separate retaining member may be provided for retaining the screen in its proper position in the mixing container.

An opening (not shown) is provided near the bottom of the mixing container 14, either on the sidewall or the bottom, to form a fluid passage between the dispenser and the ring shaped space. Although referred to as a fluid passage, thick or chunky ingredients may pass through it and be dispensed from the dispenser. The cylindrical portion of the screen 34 has a plurality of elongated vertical slots 34c. The slots regulate the size of the crushed or blended content (such as ice) that passes through the screen to reach the fluid passage to the dispenser. The slots may also function to help breaking up the ingredients in the mixing container such as ice. To this end, the cylindrical, slotted portion of the screen 34 is preferably made of metal or other strong materials. The flange portion of the screen may be made of plastic, metal or other suitable materials, and preferably has a plurality of suitably sized slots to regulate the size of the contents that can pass through it to reach the dispenser.

The blender 10 may employ either a DC motor or an AC motor to drive the grinding and shaving blade assembly. In one embodiment, a DC motor is employed, and the blender has a built-in transformer and AC-DC converter that converts household AC power to an appropriate DC voltage to power the blender. Alternatively, an AC motor may be provided with a built-in DC-AC converter. Thus, such a blender may be directly plugged into a DC source, such as a 12 V source provided by a car battery or a battery on a boat; or it may be plugged into a 120 V household AC outlet (see FIG. 2, showing two power cords 28a and 28b). The switch 24 may be provided with three positions, namely, OFF, 12 V DC ON and 120 V AC ON to run on different sources of power. Alternatively, two switches may be provided, one for AC or DC selection and the other for ON/OFF function.

In operation, the lid 16 is removed or opened and ingredients are loaded from the top of the mixing container 14. The lid is replaced or closed, and the motor is turned on to crush and/or blend the ingredients. The crushed and/or blended ingredients are filtered by the screen 34 and can be dispensed from the dispenser 18. After use, the mixing container 14 can be removed from the base, and the screen 34 can be removed from inside the container for easy cleaning.

In one embodiment, a see-though window is provided on the lid 16 to allow the user to observe the process of blending and determine when the content has been blended to satisfaction. The window may have a round shape or other shapes. Alternatively, a see through window may be provided on the sidewall of the mixing container.

Blenders according to embodiments of the present invention are suitable for both home and commercial use.

It will be apparent to those skilled in the art that various modification and variations can be made in the blender device of the present invention without departing from the spirit or scope of the invention. Thus, it is intended that the present invention cover modifications and variations that come within the scope of the appended claims and their equivalents.

What is claimed is:

1. A blender comprising:
a base for housing a motor;
a mixing container mounted on top of the base, the mixing container having a dispenser for dispensing a content from the container;
a lid for covering the mixing container; and
a grinding and shaving assembly disposed inside the mixing container near its bottom, the grinding and shaving assembly including a grinding and shaving blade assembly attached to a rotating shaft and a screen disposed around the grinding and shaving blade assembly, the screen being spaced from an inner sidewall of the mixing container to form a space between the screen and the inner sidewall, and
wherein an opening is defined near a bottom of the mixing container to form a fluid passage between the space and the dispenser.

2. The blender of claim 1, wherein the mixing container is removably mounted on top of the base.

3. The blender of claim 2, further comprising locking members adapted for locking the mixing container to the base.

4. The blender of claim 1, wherein the mixing container is insulated.

5. The blender of claim 1, further comprising a handle located on the mixing container.

6. The blender of claim 1, wherein the screen has a cylindrical shape.

7. The blender of claim 1, wherein the screen defines a plurality of vertical slots on its side surface.

8. The blender of claim 1, wherein the screen is made of metal.

9. The blender of claim 1, wherein the screen is removably disposed within the mixing container.

10. The blender of claim 1, wherein the screen includes a flange portion having an outer dimension substantially the same as an inner dimension of the mixing container.

11. The blender of claim 10, wherein the flange portion has one or more locking clips for locking the screen inside the mixing container.

12. The blender of claim 1, wherein the grinding and shaving blade assembly includes a rotating base plate attached to and rotating with the rotating shaft, and one or more swiveling metal cutting blades attached to the base plate at off-centered positions.

13. The blender of claim 1, wherein the lid is removable and has one or more protrusions on its lower surface, and wherein the mixing container has one or more holes for receiving the protrusions.

14. The blender of claim 13, further including one or more safety switches inside the holes which are activated when the protrusions on the lid are inserted into the holes.

15. The blender of claim 1, wherein the rotating shaft protrudes from a bottom of the mixing container and has a head, and wherein the base includes a rotating socket for engaging the head of the rotating shaft.

16. The blender of claim 1, further including a motor housed in the base.

17. The blender of claim 16, wherein the motor is a DC motor, the blender further including an AC-DC converter.

18. The blender of claim 16, wherein the motor is an AC motor, the blender further including a DC-AC converter.

19. The blender of claim 1, wherein the lid includes a see-through window.
